(19) United States
(12) Patent Application Publication
(10) Pub. No.: US 2005/0025910 A1
(43) Pub. Date: Feb. 3, 2005

(54) Interior fitting for motor vehicles and method for producing the interior fitting

(75) Inventor: Martin Ehrath, Goeppingen (DE)

Correspondence Address: LAW OFFICE OF BARRY R LIPSITZ, 755 MAIN STREET, MONROE, CT, 06468, US

(73) Assignee: Erwin Behr Automotive GmbH, Wendlingen (DE)

(21) Appl. No.: 10/640,511

(22) Filed: Aug. 13, 2003

Related U.S. Application Data
(63) Continuation of application No. PCT/EP02/01473, filed on Feb. 13, 2002.

(30) Foreign Application Priority Data
Feb. 15, 2001 (DE) 101 07 038.1

(51) Int. Cl. B60R 13/00

(52) U.S. Cl. 428/31

(57) ABSTRACT

The invention relates to an interior fitting for the trim of a motor vehicle interior. Said interior fitting comprises a base element and a coating which at least partially covers at least the visible side of said base element. The aim of the invention is to develop one such interior fitting in such a way that it has a long-lasting surface quality. To this end, the coating comprises an outer layer element which is fixed to the base element by means of a connection layer. The invention also relates to a method for producing one such interior fitting.

The present invention relates to the subject matter disclosed in international application No. PCT/EP02/01473 of Feb. 13, 2002, which is incorporated herein by reference in its entirety and for all purposes.

### BACKGROUND OF THE INVENTION

The invention relates to an interior fitting with the features of the preamble of claim 1 and to a method for producing it.

Interior fittings with a coated, for example varnished, base part are frequently used for the interior trim of motor vehicles. Wooden molded parts, which may be of a solid form or formed as veneer parts, are especially used as base parts. On the visible side of the base part, it is usual for a coating in the form of a transparent varnish or resin layer to be applied, so that a usually shiny and long-lasting surface is produced. The base part is thereby sealed on the visible side and its structure is additionally emphasized. For this purpose, the base part is usually coated with a layer of varnish about 0.5 to around 0.8 mm thick.

The production of the coating generally takes place by the varnish being sprayed or painted onto the surface of the base part to be coated. To obtain the desired sealing and a shiny surface emphasizing the structure of the base part, a number of layers are required for this. This entails considerable expenditure in terms of cost and time.

In DE-C-43 20 893 it is proposed to place the base part into a cavity of a mold part, a gap being formed between the surface region of the base part to be coated and the associated wall of the cavity and filled with a liquid surface coating material, which subsequently cures.

Although the use of a coating in the form of a layer of varnish which is produced either by spraying on or by a molding operation as explained above lends the interior fitting an optically appealing effect and also produces a sealing effect, in particular when base parts produced from wood are used, the desired long-lasting surface quality of the interior fitting cannot be ensured in all cases.

DE-A-199 09 869 discloses an interior fitting in which a base part in the form of a carrier element is coated on the visible side with an adhesive, and a decorative layer, for example a frangible thin layer of stone, is then applied to the layer of adhesive. The decorative layer is covered with an elastic element, for example a rubber sheet, which is then subjected to pressure for adhesively bonding the decorative layer to the carrier element. Subsequently, the elastic element is removed from the decorative layer again by exposure to heat and/or exposure to a solvent.

In U.S. Pat. No. 3,551,232 there is a description of an interior fitting with a substrate and an outer layer, in which the substrate has a multiplicity of through-openings. The substrate is coated on the visible side with an adhesive, on which the outer layer is then positioned. On the rear side, facing away from the outer layer, the substrate is subsequently subjected to a negative pressure and the outer layer is heated, so that it is sucked through the through-openings of the substrate, adapts itself in its form to the profile of the substrate and is adhesively bonded to the substrate. An interior fitting which is produced using a similar vacuum forming process is disclosed in U.S. Pat. No. 5,629,085.

It is an object of the present invention to develop an interior fitting of the generic type in such a way that it has an improved surface quality.

### SUMMARY OF THE INVENTION

This object is achieved according to the invention in the case of an interior fitting of the type stated at the beginning by the connecting layer comprising a connecting material which is introduced between the base part and the outer layer element under application of pressure.

The forming of the coating with an outer layer element and a connecting layer has the advantage that the individual layer elements can be respectively optimized for different functional requirements of the coating, so that for example a sealing of the base part and also both an appealing esthetic effect and a long-lasting surface quality are ensured. The sealing may in this case take place by means of the connecting layer, while a high abrasion resistance and the long-lasting surface quality of the coating are ensured by the use of an outer layer element.

According to the invention, the connecting layer comprises a connecting material which is introduced between the base part and the outer layer element under application of pressure. For example, it may be provided that the connecting material can be pressed between the base part and the outer layer element by means of a piston-cylinder unit.

It is advantageous if the connecting material can be introduced by means of a positive pressure of around 0.3 bar to about 3.5 bar, preferably 0.5 bar to 2 bar. The use of such a positive pressure ensures that the connecting material in the liquid state distributes itself uniformly between the base part and the outer layer element, with virtually no gas bubbles being formed.

It is of particular advantage if the connecting layer comprises a connecting material which can be introduced in the liquid state between the base part and the outer layer element and subsequently can be cured. This permits efficient production of the interior fitting, with short process times being achievable, in that the base part and the outer layer element are placed one on top of the other and a liquid connecting material is subsequently introduced between the base part and the outer layer element and then cures. The connecting material may not only serve for the sealing of the base part and the fixing of the outer layer element, but may additionally perform a buffering function, in order to compensate for the different thermal expansions of the base part and the outer layer element. The outer layer element in turn not only provides the interior fitting with a high surface quality, but reduces the gas emission of toxic substances, for example styrene, which are used for the connecting material. The finished interior fitting is therefore also distinguished by particularly low gas emission of harmful substances.

Especially low-cost production of the interior fitting can be achieved by the connecting material being able to be cured by being subjected to UV radiation. For this purpose, it may be provided that the connecting material comprises UV-radiation-sensitive sensitizers, which are selected in such a way that, when they are subjected to UV radiation, they trigger a chain reaction which leads to curing of the connecting material. The proportion of UV-radiation-sensitive sensitizers is preferably chosen such that, when it is subjected to UV radiation, the connecting material cures within a time period of a few minutes, for example less than 3 minutes, at least to the extent that the interior fitting can be handled. The application of a coating to the base part can consequently be carried out within a few minutes.

The connecting material is preferably transparent in the cured state, since this allows the esthetic effect of the interior fitting to be additionally improved.

The connecting layer may for example comprise a layer of adhesive, with a two-component adhesive especially being used.

In the case of a particularly preferred embodiment it is provided that the connecting layer comprises a layer of varnish or resin. In this case, a synthetic resin material may be used especially, for example a polyester or a polyurethane-, acrylic- or epoxy-based synthetic resin.

The fixing of the outer layer element on the visible side of the base part takes place, as explained, by means of the connecting layer. The outer layer element consequently does not have to have any holding function.

To achieve an esthetically especially advantageous surface quality of the interior fitting, it is advantageous if the outer layer element is produced from a transparent material.

The outer layer element is preferably produced from plastic. Thermoplastics have proven to be advantageous for this, especially polycarbonates.

In the case of an embodiment of the interior fitting according to the invention which can be produced at particularly low cost, the outer layer element is produced from a film. The use of a film permits easy handling. In particular, the film can be preformed, for example deep drawn, at low cost. In this case, it is advantageous if the film can be clamped onto the base part to be coated.

It is of advantage if the film can be applied to the base part by deep drawing. For this purpose, a deep drawing installation known per se can be used, with the aid of which the base part can be coated with the film.

The thickness of the preformed film may comprise in particular about 50% to approximately 90% of the overall layer thickness of the coating, preferably a thickness of approximately 0.4 mm to around 0.7 mm.

Alternatively it may be provided that the outer layer element takes the form of a prefabricated injection-molded part. The injection-molded part can preferably be placed on the visible side of the base part and fixed on the latter by means of the connecting layer.

It is of particular advantage if the injection-molded part is shaped in the form of a shell, since the mounting of the interior fitting is simplified as a result. Particularly simple mounting can be achieved by it being possible for the injection-molded part to be placed onto the base part.

To increase the esthetic effect of the interior fitting, it may be provided that a decorative material or various decorative materials are disposed between the outer layer element and the base part. For this purpose, textiles, shavings, natural materials, such as for example leaves, horn, sand and the like, glass-fiber and/or carbon-fiber fabric or any other visually appealing substances can be used especially. The decorative materials are fixed on the base part by means of the connecting layer and subsequently covered by the outer layer element. The connecting layer may completely surround the decorative materials.

The connecting layer may not only be used for fixing the outer layer element, but additionally serve for fixing a supporting element, supporting the base part on the rear side. For this purpose, it may be provided that the connecting layer is disposed on the visible side and on the rear side of the base part and that the base part is held on the rear side by the supporting element, which is fixed on the base part by means of the connecting layer. It may be provided in particular that the connecting layer completely surrounds the base part, so that the base part is sealed on all sides. The supporting element lends the base part the desired dimensional stability and can be fixed on the base part by means of the connecting layer. In addition, the supporting element may comprise holding parts, with the aid of which the interior fitting can be fastened in the interior of a motor vehicle.

Decorative parts, for example a textile material, mineral substances, wood and in particular a laminate which is preformed but not independently dimensionally stable, for example with use of a wood veneer, may be used especially as the base part.

It is of particular advantage if the supporting element is produced from a transparent material, in particular from a plastics material.

It has proven to be advantageous to form the supporting element as a prefabricated injection-molded part, especially shaped in the form of a shell, which can preferably be mounted on the rear side of the base part.

It is advantageous if the supporting element has a receptacle for a lighting element, since this provides the possibility of backlighting the interior fitting in a visually appealing manner.

As mentioned at the beginning, the invention also relates to a method for producing an interior fitting with improved abrasion resistance.

This object is achieved by a method with the features of claim 23.

The method according to the invention is distinguished inter alia by the fact that an outer layer element is preformed and clamped to the base part, in order to introduce between the outer layer element and the base part the connecting material in the liquid state and cure it.

It is of advantage if the outer layer element is produced from a plastics material, for example in the form of a film of plastic. This provides the possibility of preforming the outer layer element, preferably by a deep drawing process. It is particularly advantageous here if the outer layer element is applied to the base part by deep drawing and is subsequently clamped to the latter. This permits especially low-cost production of the internal fitting, since the molding of the outer layer element can be performed at the same time as it is applied to the base part.

Alternatively, it may be provided that the outer layer element is preformed by an injection-molding process, for example in the form of a half shell which can be joined together with the base part.

In the case of a particularly preferred embodiment of the method according to the invention, it is provided that the preformed outer layer element and the base part are positioned in a receptacle of a mold and clamped to the mold by means of a clamping device. Subsequently, the liquid connecting material can be forced between the rear side of the outer layer element and the visible side of the base part. The mold may be adapted in a low-cost way to the three-dimensional surface shaping of the visible side of the outer layer element, so that the outer layer element can be supported over its surface area by the mold during clamping to the base part.

It is of particular advantage if a UV-radiation-permeable mold is used, for example a glass or silicone mold, which preferably has a receptacle shaped in the form of a pan.

A synthetic resin varnish is preferably used as the connecting material, especially a synthetic resin varnish which can be cured by means of UV radiation. This makes it possible to cure the connecting material within a short time, for example within less than around 3 minutes, while the outer layer element and the base part are clamped to the mold by means of the clamping device.

According to an advantageous development of the method, it is provided that at least one decorative material, for example leaves, horn, sand, wood shavings or the like, is disposed between the outer layer element and the base part.

Here it may be provided that the preformed outer layer element is in the first instance positioned in the receptacle of the mold, the decorative material is subsequently disposed on the rear side of the decorative layer element, in a further method step the base part is placed onto the decorative material and is then clamped to the outer layer element by means of the clamping device. In a subsequent method step, the connecting material in liquid form can then be forced between the outer layer element and the base part and be cured—preferably by means of UV radiation.

### BRIEF DESCRIPTION OF THE DRAWINGS

FIG. 1 shows a base part clamped onto a deep drawing mold of a deep drawing installation;

FIG. 2 shows the base part according to FIG. 1 with the outer layer element drawn on;

FIG. 3 shows the base part with the outer layer element drawn on according to FIG. 2 when the connecting material is being introduced between the base part and the outer layer element;

FIG. 4 shows the base part with the outer layer element drawn on according to FIG. 2 when the connecting material is being cured;

FIG. 5 shows a finished interior fitting according to a first embodiment of the invention;

FIG. 6 shows an interior fitting according to a second embodiment of the invention when a connecting element is being cured and

FIG. 7 shows the finished interior fitting according to FIG. 6.

### DETAILED DESCRIPTION OF THE INVENTION

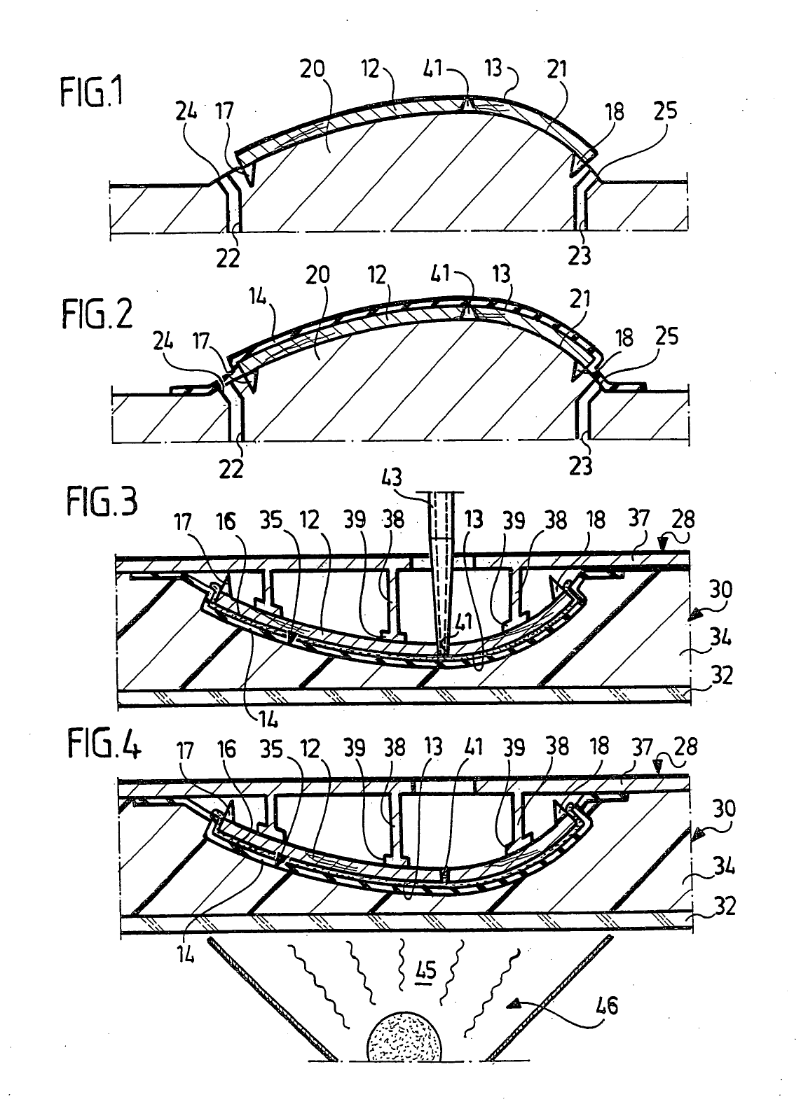

In FIGS. 1 to 4, four method steps for the production of an interior fitting according to a first embodiment of the invention, schematically represented in FIG. 5, are represented in a schematic representation.

The interior fitting is designated in FIG. 5 by the reference numeral 10 and comprises a base part 12, which is coated on its visible side 13 by an outer layer element 14 in the form of a polycarbonate (PC) film around 0.4 mm to around 0.7 mm thick, with a connecting layer in the form of a layer of transparent varnish 16 being disposed between the PC film 14 and the visible side 13 of the base part 12. On the rear side, the base part 12 carries holding parts in the form of latching elements 17, 18, with the aid of which the internal fitting 10 can be fastened in the interior of a motor vehicle. The interior fitting 10 has a clearance 48 and, as a result, can be mounted for example on a control element of the motor vehicle.

The base part 12 forms a decorative part and, in the exemplary embodiment represented, takes the form of a wood veneer part. However, it may also be provided for the base part to take the form of a metal part for example, especially an aluminum part, preferably a printed aluminum part. Furthermore, a leather part or a textile material stabilized on its rear side, for example a carbon fabric, may be used for example as the base part. It is also possible to combine a number of materials to form a base part. Furthermore, it may be provided for the base part to take the form of a rear part supporting the interior fitting on the rear side, which at most is given a secondary decorative function but, facing the outer layer element, receives an embellishing decorative material, as explained further below.

Like the layer of varnish 16, the PC film 14 takes a transparent form and is distinguished by especially high abrasion resistance. The layer of varnish 16 is produced from a synthetic resin, for example based on a polyester, polyurethane or acrylic- or epoxy-based. The layer of varnish 16 effects a sealing of the visible side 13 of the base part 12 and serves at the same time as a buffering layer, with the aid of which it is possible to compensate for the different thermal expansions of the base part 12 and the PC film 14.

The production of the interior fitting 10 is explained in more detail below with reference to FIGS. 1 to 4. In a first method step, the preformed base part 12, provided on the rear side with the latching elements 17 and 18, is clamped onto a deep drawing mold 20 of a deep drawing installation, said mold being known per se and therefore only represented schematically in the drawing. The latter has a supporting surface 21, which is adapted to the shape of the base part 12, and, at a distance from the base part 12, suction channels 22, 23, which open out into the supporting surface 21, are in flow connection with a suction source not represented in the drawing, for example a pump, and can be subjected to a negative pressure.

In a second method step, schematically represented in FIG. 2, the PC film 14 is placed onto the visible side 13 of the base part 12. The film 14 is chosen here to be larger than the visible side 13 of the base part 12, so that it covers over the mouth regions 24 and 25 of the suction channels 22 and 23. Subsequently, the suction channels 22 and 23 are subjected to negative pressure, so that the PC film 14 is drawn over the base part 12 on the visible side. The PC film 14 hereby adapts itself completely to the shape of the visible side 13 of the base part 12.

In a further method step, illustrated in FIG. 3, the base part 12 with the drawn-on PC film 14 is removed from the thermoforming mold 20 and clamped to a mold part 30 by means of a clamping device 28. The mold part 30 comprises a carrying plate 32 made of a UV-radiation-permeable plastics or glass material, preferably quartz glass, which has only low absorption for ultraviolet (UV) radiation. The carrying plate 32 carries a mold 34, which has on its side facing away from the carrying plate 32 a pan-shaped receptacle 35, adapted to the shaping of the visible side 13 of the base part 12 covered with the PC film 14. The mold 34 is likewise produced from a UV-radiation-permeable material, preferably from a silicone material.

The clamping device 38 comprises a clamping lever 37, from which there protrude in the direction of the carrying plate 32 a number of clamping pins 38, which respectively carry at their free end a clamping plate 39, which engages against the rear side of the base part 12, so that the latter is held undisplaceably within the pan-shaped receptacle 35.

The base part 12 has a filling opening 41 passing through it, which is covered over on the visible side by the PC film 14. A liquid synthetic resin varnish is injected into the region between the visible side 13 of the base part 12 and the PC film 14 via the filling opening 41 by means of a filling nozzle 43. The synthetic resin varnish distributes itself over the entire visible side 13 of the base part 12 and subsequently—as represented in FIG. 4—can be cured by means of UV radiation 45, which is provided by a UV radiation source 46 disposed underneath the carrying plate 32.

After the curing of the varnish, the base part 12 covered with the PC film 14 on the visible side can be removed from the mold part 30. Further surface working of the interior fitting 10 to improve its surface quality is not required. In the case of the exemplary embodiment according to FIG. 5, it is merely provided that, after removal from the mold part 30, the clearance 48 is introduced into the interior fitting 10, for example by milling. The clearance 48 is disposed here in a region in which the filling opening 41 of the base part 12 was originally positioned. If no such clearance 48 is provided on the finished interior fitting 10, the introduction of the varnish into the intermediate space between the visible side 13 of the base part 12 and the PC film 14 by means of the filling nozzle 43 can be performed in an edge region of the base part 12, for example directly alongside a latching element 17 or 18.

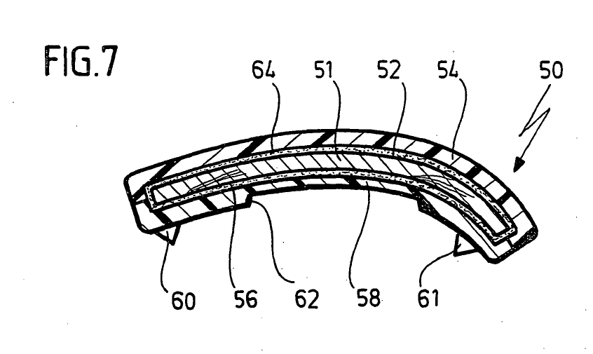

A second embodiment of an interior fitting according to the invention is schematically represented in FIG. 7. It is designated overall by the reference numeral 50 and comprises a base part 51, which in the exemplary embodiment represented is likewise produced using wood. While in the exemplary embodiment described above the base part is covered by an outer layer element in the form of a film of plastic 14, the base part 51 of the interior fitting 50 is covered over on its visible side 52 by an outer layer element in the form of a front plastics shell 54, formed as a prefabricated injection-molded part. Disposed on the rear side 56 of the base part 51 is a rear plastics shell 58, which likewise takes the form of a prefabricated injection-molded part and forms a supporting element for the base part 51 and has on its outer side facing away from the rear side 56 formed-on latching elements 60, 61 and also a receptacle 62, which receives a lighting element when the interior fitting 50 is fitted into the interior of a motor vehicle.

The front plastics shell 54 and the rear plastics shell 58 form a housing completely surrounding the base part 51 and are respectively produced from a transparent plastic by the injection-molding process. Disposed between the plastics shells 54 and 58 on the one hand and the base part 51 on the other hand is a connecting layer, completely surrounding the base part 51, in the form of a layer of varnish 64, which likewise takes a transparent form and fixes the front plastics shell 54 and the rear plastics shell 58 on the base part 51.

Since the plastics shells 54 and 58 and the layer of varnish 64 are of a transparent form, the interior fitting 50 can be backlit in a simple way by means of the lighting element to be positioned in the receptacle 63, so that the interior fitting 50 is distinguished by an esthetically especially pleasing configuration.

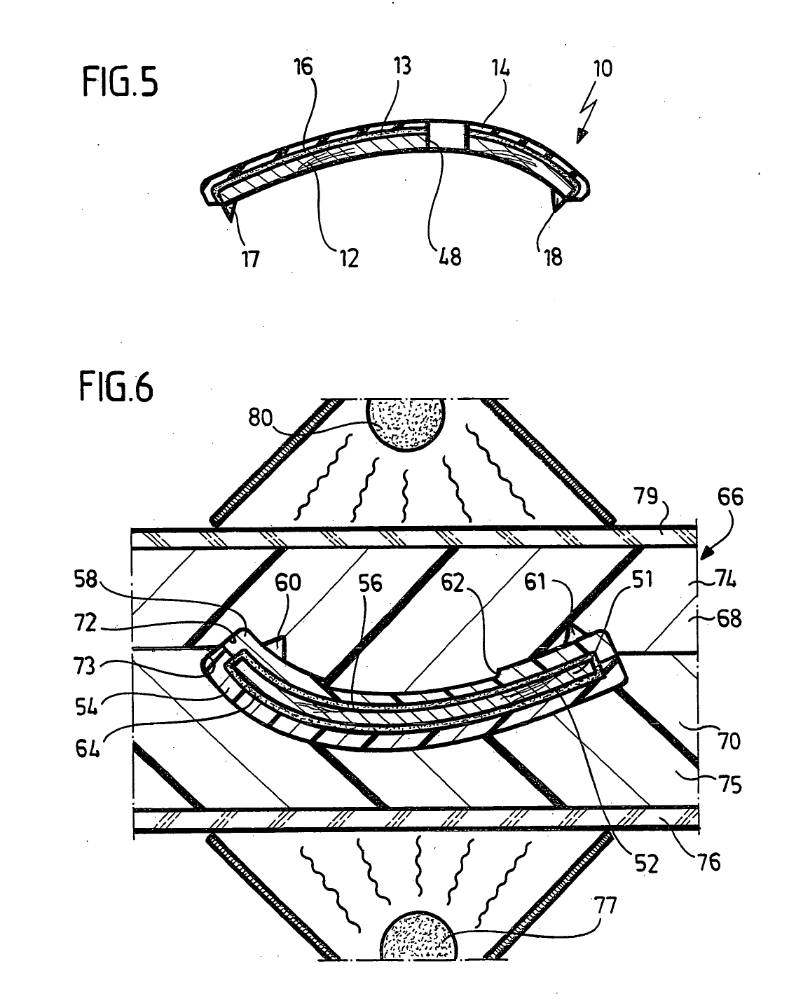

The production of the interior fitting 50 is illustrated especially clearly by FIG. 6. In a way corresponding to the statements made with respect to FIGS. 3 and 4, in the production of the interior fitting 50 a mold part 66 is provided. This comprises an upper mold 68 and a lower mold 70, which, facing each other, respectively have a dish-shaped receptacle 72 and 73. The upper mold 68 and the lower mold 70 respectively comprise a mold 74 and 75 which is produced from a UV-radiation-permeable material, especially a silicone material, and into which the pan-shaped receptacles 72 and 73 have been introduced. The lower mold 70 also comprises a carrying plate 76, which is produced from a UV-radiation-permeable material, especially from quartz glass, and supports the mold 75. Positioned underneath the carrying plate 76 is a lower UV radiation source 77.

The upper mold 68 has on its upper side, facing away from the dish-shaped receptacle 72, a top plate 79, which is produced from a UV-radiation-permeable material, preferably from quartz glass. Disposed above the top plate 79 is an upper UV radiation source 80.

In a first method step, with the upper and lower molds 68, 70 still separated, the front plastics shell 54 of the interior component 50, prefabricated by the injection-molding process, is introduced into the pan-shaped receptacle 73 of the lower mold 70. Subsequently, the base part 51 is positioned in the plastics shell 54. In a further method step, the rear plastics shell 58 is then placed onto the rear side of the base part 51, and subsequently the mold part 66 is closed. Then, a liquid synthetic resin varnish is forced into the intermediate space between the base part 51 on the one hand and the front and rear plastics shells 54 and 58 on the other hand via a filling channel not represented in the drawing. The still liquid synthetic resin varnish here surrounds the base part 51 completely and is subsequently cured by being subjected on both sides to UV radiation within the mold part 66 by means of the lower radiation source 77 and the upper radiation source 80. The cured layer of varnish 64 forms a connecting layer reliably connecting the plastics shells 54 and 58 on the base part 51 and also represents a buffer, with the aid of which it is possible to compensate for the different thermal expansions of the plastics shells 54 and 58 on the one hand and of the base part 51 on the other hand.

The plastics shells 54 and 58 form a transparent covering for the base part 51. This provides the possibility of disposing additional decorative materials between the base part 51 and the plastics shells 54 and 58. For example, it may be provided that natural materials such as for example leaves, horn, sand etc. are positioned on the rear side of the front plastics shell 54, facing the base part 51, before the base part 51 is placed onto the front plastics shell 54.

Subsequently, as explained above, the varnish can be forced in, completely surrounding the decorative material, and then cured. As a result, the esthetic effect of the interior fitting 50 can be additionally improved.

1. Interior fitting for the trim of a motor vehicle interior, with a base part and a coating, covering over at least certain regions of at least the visible side of the base part, the coating comprising an outer layer element, which is fixed on the base part by means of a connecting layer, wherein the connecting layer comprises a connecting material which is introduced between the base part and the outer layer element under application of pressure.

2. Interior fitting according to claim 1, wherein the connecting layer comprises a connecting material which can be introduced in the liquid state between the base part and the outer layer element and subsequently can be cured.

3. Interior fitting according to claim 1, wherein the connecting material can be cured by being subjected to UV radiation.

4. Interior fitting according to claim 1, wherein the connecting material is transparent in the cured state.

5. Interior fitting according to claim 1, wherein the connecting layer comprises a layer of varnish or resin.

6. Interior fitting according to claim 1, wherein the connecting layer comprises a synthetic resin material.

7. Interior fitting according to claim 1, wherein the outer layer element is produced from a transparent material.

8. Interior fitting according to claim 1, wherein the outer layer element is produced from plastic.

9. Interior fitting according to claim 1, wherein the outer layer element is produced from a film.

10. Interior fitting according to claim 9, wherein the film is preformed.

11. Interior fitting according to claim 9, wherein the film is preformed by deep drawing.

12. Interior fitting according to claim 9, wherein the film can be applied to the base part by deep drawing performed over the base part.

13. Interior fitting according to claim 1, wherein the outer layer element takes the form of a prefabricated injection-molded part.

14. Interior fitting according to claim 13, wherein the injection-molded part is shaped in the form of a shell.

15. Interior fitting according to claim 13, wherein the injection-molded part can be placed onto the base part.

16. Interior fitting according to claim 1, wherein the base part takes the form of a decorative part.

17. Interior fitting according to claim 16, wherein the decorative part comprises a wooden molded part.

18. Interior fitting according to claim 1, wherein at least one decorative material is disposed between the outer layer element and the base part.

19. Interior fitting according to claim 1, wherein the connecting layer is disposed on the visible side and on the rear side of the base part, and the base part is held on the rear side by a supporting element, which is fixed on the base part by means of the connecting layer.

20. Interior fitting according to claim 19, wherein the supporting element is produced from a transparent material.

21. Interior fitting according to claim 19, wherein the supporting element is produced as a prefabricated injection-molded part.

22. Interior fitting according to claim 19, wherein the supporting element has a receptacle for a lighting element.

23. Method for producing an interior fitting according to claim 1, wherein a preformed outer layer element is clamped to a base part, and a liquid connecting material is forced between the outer layer element and the base part and is subsequently cured.

24. Method according to claim 23, wherein the outer layer element is produced from a plastics material.

25. Method according to claim 24, wherein the outer layer element is produced from a film of plastic.

26. Method according to claim 23, wherein the outer layer element is preformed by deep drawing.

27. Method according to claim 26, wherein the outer layer element is applied to the base part by deep drawing and is subsequently clamped to the latter.

28. Method according to claim 23, wherein the outer layer element is preformed by injection molding.

29. Method according to claim 23, wherein the preformed outer layer element and the base part are positioned in a receptacle of a mold and clamped to the mold by means of a clamping device.

30. Method according to claim 29,wherein a UV-radiation-permeable mold is used.

31. Method according to claim 23, wherein a synthetic resin varnish is used as the connecting material.

32. Method according to claim 23, wherein a synthetic resin varnish which can be cured by means of UV radiation is used as the connecting material.

33. Method according to claim 29, wherein at least one decorative material is disposed between the outer layer element and the base part.
